(19) United States
(12) Patent Application Publication
(10) Pub. No.: US 2008/0295423 A1
(43) Pub. Date: Dec. 4, 2008

(54) Window treatment system

(76) Inventor: Lisa E. Libretti-Landolfi, Shirley, NY (US)

Correspondence Address: Thomas A. O'Rourke;Bodner & O'Rourke, LLP, Suite 108, 425 Broadhollow Road, Melville, NY, 11747, US

(21) Appl. No.: 12/150,444

(22) Filed: Apr. 28, 2008

Related U.S. Application Data
(60) Provisional application No. 60/926,320, filed on Apr. 26, 2007.

(51) Int. Cl. E06B 3/30

(52) U.S. Cl. 52/204.53; 52/204.59

(57) ABSTRACT

A window treatment system is disclosed. The system has a first end member and a second end member. The end members have a top surface and a sidewall extending downwardly from the top surface. There is also an end wall at one end of the end members. There may be one or more center members between the end members. The top ledges and the sidewalls are generally in the same plane thereby creating the appearance of a unitary structure or frame for securing a window treatment thereto.

This application claims priority on U.S. Provisional Patent Application Ser. No. 60/926,320 filed on Apr. 26, 2007 the disclosures of which are incorporated herein by reference.

### FIELD OF THE INVENTION

The present invention is directed to an improved window treatment system. More particularly the window treatment system permits a home owner, designer or decorator to easily install window treatments. More specifically the present invention is directed to a system of hanging cornices or valence frames to which fabric may be secured.

### BACKGROUND OF THE INVENTION

Many homeowners designers and decorators seek to dress up windows to make them more attractive. These decorations can extend from blinds to curtains and drapes. In many instances there is a desire to add more elaborate decorations to a window. These window treatments can include scarves and swags. Scarves and swags are pieces of fabric that are draped artfully over the top of the window and down the sides. They may be stopped partway down the window or go all the way to the floor. Sometimes they are hung on a board that is installed over the window. This board may have a length that extends from one side of the window to the other and have a flat surface that extends outwardly from the window or the wall surface.

Though the terms are sometimes used interchangeably, a scarf is usually a single piece of fabric and a swag is made of several pieces joined together. The reason for forming a swag from more than one piece is so that it will drape in a characteristic curved shape. Rather than have swags sewn, decorators often just pin pieces of fabric until they find a shape that works, then staple them neatly together. The same suppliers who offer curtain and drapery panels also sell scarves and swags that are ready for draping.

Draping scarves and swags attractively takes some time and expertise, though various tools and techniques will help. Assorted decorative brackets, including those labeled “scarf holder,” “swag holder,” or “sconce,” are popular for securing the fabric at the top corners of the window; an extra holder is typically used in the middle for wide windows. The fabric is threaded through the holders, or drape it over their tops. The holders may be used with or without a pole or rod. Holdbacks are another type of hardware that you can use to secure long scarves or cascades at the sides of windows. In addition to serving an important function, the various hardware pieces can add decorative accents to the window.

Another simple approach is to install a pole or rod, then loosely wrap a scarf around it or anchor a swag to it. Fabric can be stapled to a wooden pole to keep it in place. Some manufacturers of window-treatment hardware produce rubber pads for pinning fabric to metal rods. The hardware makers also turn out plastic templates, some of them labeled “design rings,” to help a user form poufs or rosettes, or arrange fabric artistically in other ways. With valance pleaters (notched plastic that you install at the top corners of the window), fabric can be draped in addition to forming valances.

Another type of window treatment is a cornice. This is a shallow, boxlike frame installed across the top of a window. (If the frame has legs that extend to the floor, it is called a lambrequin.) The frame projects out from the window, hiding a curtain or drapery heading or the tops of any other undertreatments. Cornices are traditionally built of wood, then padded and upholstered in fabric. Modern ready-made versions are often constructed of molded polystyrene or other lightweight materials, usually with facades that resemble oversized crown molding. The frame is closed at the top to keep dust away from any undertreatments. Manufacturers typically offer these frames in a couple of colors and in several widths and heights, to about 9 inches high. They suggest customizing the cornice by adding paint, wallpaper, fabric, or rubber-stamp impressions, or by gluing on decorative objects for a three-dimensional look.

### OBJECTS OF THE INVENTION

It is an object of the invention to provide a modular system of framing members to install a window valance on a variety of different windows.

It is also an object of the invention to provide a system for installing a valance or cornice over a window. It is an object of the invention to provide an improved system for making window treatments.

It is a further object of the invention to provide a means for hanging draperies and the like.

It is still another object of the invention to provide a system for making it easier for homeowners, designers and decorators to hang draperies and the like.

It is a further object of the invention to provide a system that may be easily hung on a wall to enable a homeowner, decorator or designer to hang draperies, valances, cornices, canopies and the like.

### SUMMARY OF THE INVENTION

The system of the present invention is an improved method of installing a valance, cornice etc. for a window treatment. The system is a modular one that permits the user to use the system for a variety of window sizes. The system also includes a means for hanging draperies and the like. There are one or more support members that may be secured to a wall or the trim of a window depending on the circumstances The support or base member is secured to the wall or the frame by suitable fasteners. The support is preferably a strip that is screwed to the wall surface or the top surface of window trim. This base member may be a metal, wood or other member to which frame members may be hung. The strip will have a length that may be cut to fit the size of the window. The strip has a top surface and a bottom surface. The bottom surface contacts a wall surface. The strip will have a top edge and a bottom edge as well as a pair of side edges. The edges extend from the top surface of the strip to the bottom surface of the strip. In one embodiment the support member may be a length metal that has a plurality of orifices along its length. These orifices are used by fasteners for securing the support member to a wall. The support member can also have a fastening means along its top surface for securing the window system thereto. In one embodiment, the fastening means may be a recess in the top surface of the support that permits the other members of the system to be removably secured to the base member. The system is typically made up of two end frame members that are mirror images of each other and one or more center frame members which can be used to apply the system to windows of varying widths.

The center frame members are typically L shaped having a top ledge and a side wall, extending downwardly there from. The ledge and sidewall are preferably at right angles to each other. The top ledge has a top surface and a bottom surface which are separated by a first edge and a second edge. Extending from the top ledge at the second edge is the sidewall. The sidewall has an inner surface and an outer surface. The first edge of the ledge is provided with a hook or other securing means for securing the center frame member to the support or base member. The top ledge and the sidewall may be secured together by any appropriate means. In one embodiment one or more “L” brackets may be used on the inner surface of the center frame member to secure the top ledge and the sidewall together. In another embodiment there may be dowels or dados in the two to fit them together and the two secured by glue or an appropriate fastener. In still another embodiment the L shaped center frame member may be a unitary piece. Depending on the weight of the fabric to be added to the system the center frame member or even the end frame members may have a block support to strengthen the L shaped member.

The end frame members are similar to the center frame members in that they have a top ledge and a sidewall, as does the center frame member. The top ledge and the sidewall are preferably at right angles to each other. In any event, in any application where two end frame members are being used or two end members and one or more center frame members are being used, the top ledges and side walls should be in the same plane so that in use they look like a single member. There is also an end wall extending from the top ledge and the sidewall. The end wall may be arranged on the end frame members so that there is a left end frame member and a right end frame member. The end wall is preferably at a right angle to the top ledge and the sidewall. As in the case of the center frame member, the first edge of the ledge is also provided with a hook or other securing means to secure the end frame members to the support member.

The end wall of the end frame member has an inner and outer surface as well. The inner surface may be provided with a means for supporting a rod for hanging draperie, curtains, ect. This means for supporting can be on both inner surfaces of the left and right end frame members. A common means for supporting drapery is a circular disk with an orifice in its center for securing the disk to the inner surface of the end wall. The disk has generally about its circumference a circular, raised portion that forms a ring for receiving an end of a rod. There are typically two disks, one on the inner surface of each of the end frame members. One of the disks has a opening in the upper portion of the raised portion of the circumference of the ring for ease of receiving the rod. In use there are two end frame members and one or more center frame members that are lined up so that the top surface of their top ledges are in generally the same plane. The top surface of top ledges are typically covered with fabric to create a valance. The fabric can be padded depending on the users preference.

### BRIEF DESCRIPTION OF THE DRAWINGS

FIG. 1 is a rear view of a representative sample of the center frame member of the system of the present invention.

FIG. 2 is a rear view of a representative sample of the left end frame member of the system of the present invention.

FIG. 3 is a rear view of a representative sample of the right end frame member of the system of the present invention.

FIG. 4 is a front view of one embodiment of the system of the present invention with a left end frame member, a right end frame member and a center frame member.

FIG. 5 is a rear view of the embodiment of FIG. 4.

FIG. 6 is a side view of the left end frame member of FIG. 2, showing a hook means to secure the frame members to the support member and a means to support a pole.

FIG. 7 is an inside view of the right end frame showing a means to support a pole.

FIG. 8 are examples of fascias that can be placed over the system. The outer surface of the end frame of the sidewall and center frame members can be in the shapes of any designs that can be used to create a canopy of different designs.

FIG. 9 is an example of a representative support member.

FIG. 10 is an example of the side profile of the support member and the securing means.

### DETAILED DESCRIPTION OF THE INVENTION

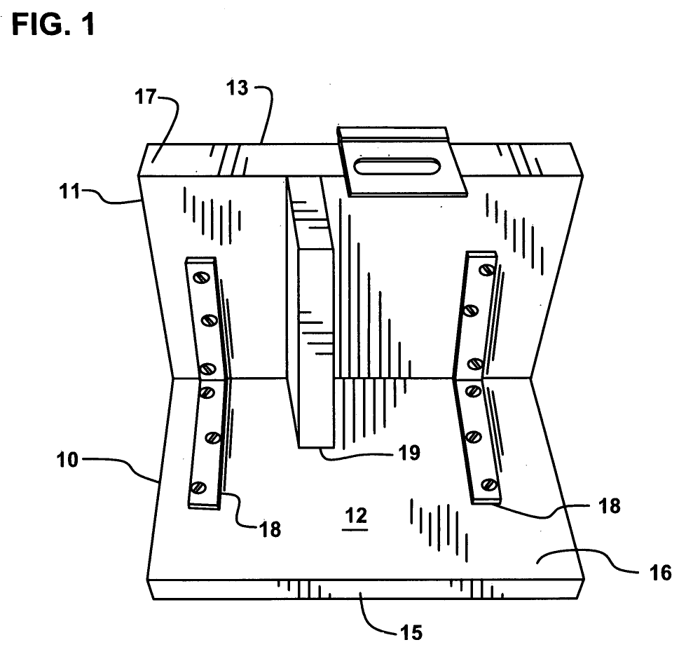

FIG. 1 shows a rear view of a center frame member 10 of the system of the present invention. The center frame member 10 has a top ledge 11 and a sidewall 12. The top ledge 11 and the sidewall 12 are preferably at right angles to each other. However depending on the design desired the angle between the top ledge and sidewall can vary. The top ledge 11 has a top or outer surface 13 and a bottom or inner surface 14. Similarly, the sidewall 12 has an outer surface 15 and an inner surface 16. The outer and inner surfaces on the sidewall 12 are separated by an edge 13. The outer and inner surfaces on the top ledge are separated by edge 17. The top ledge and sidewall may be a unitary member or may be two separate members. Where there are two separate members they may be secured by any suitable means. FIG. 1 shows the use of angle irons 18. Alternatively or in addition to the angle irons, a rectangular block 19 may be used to secure the top ledge and sidewalls. Glue, nails, screws or other fastening means can be used to secure the top ledge and the sidewall to the block. On edge 13 there may be a securing means 81 such as a hook to secure the center frame member to a support member 60.

Because the system of the present invention is designed for use on windows of differing widths, the system may have none or one or more center frame members separating the end frame members depending on the width of the windows, the width of the center frame members and the width of the end frame members.

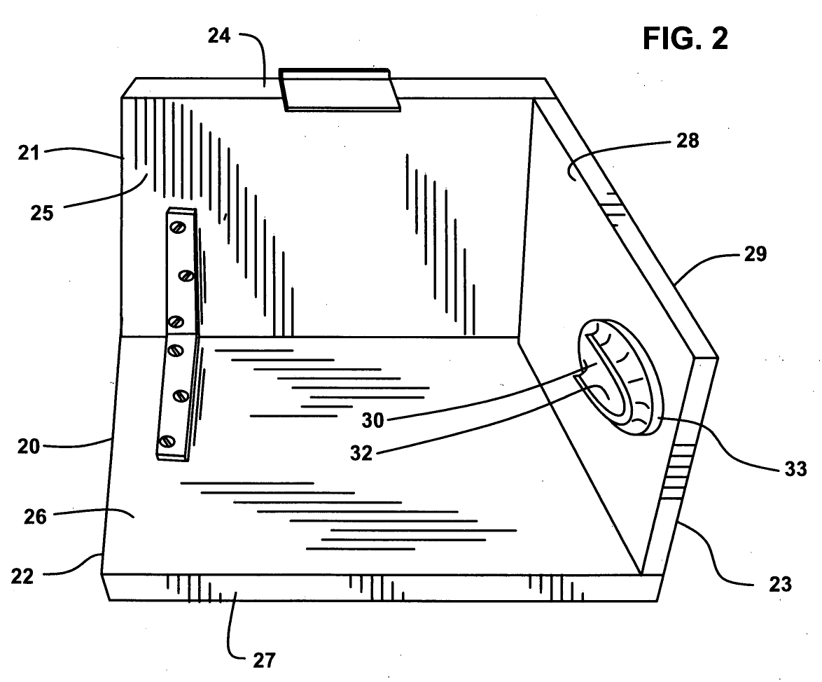

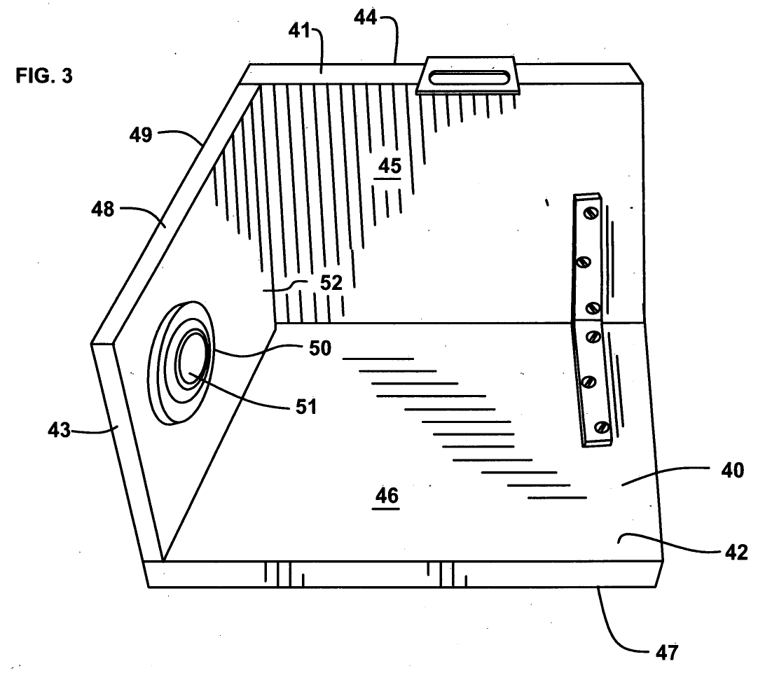

FIG. 2 shows the left end member 20. The left end member has a top ledge 21 and sidewall 22 and an end wall 23. The top ledge 21 has a top or outer surface 24 and an inner or bottom surface 25. Similarly, the sidewall has an inner surface 26 and an outer surface 27. The end wall 23 has an inner surface 28 and an outer surface 29. The top ledge 21, the sidewall 22 and the end wall 23 are generally at right angles to each other. Inner surface 28 of the end wall has a means 30 for receiving an end of a pole (not shown). The means 30 for receiving a pole can be any one of the well known end pieces for holding a pole, for example, in a closet or the like. One common type is a generally U shaped member that receives a round pole in the recessed center portion 32 of the U. The side walls 33 of the U hold the end of the pole in position.

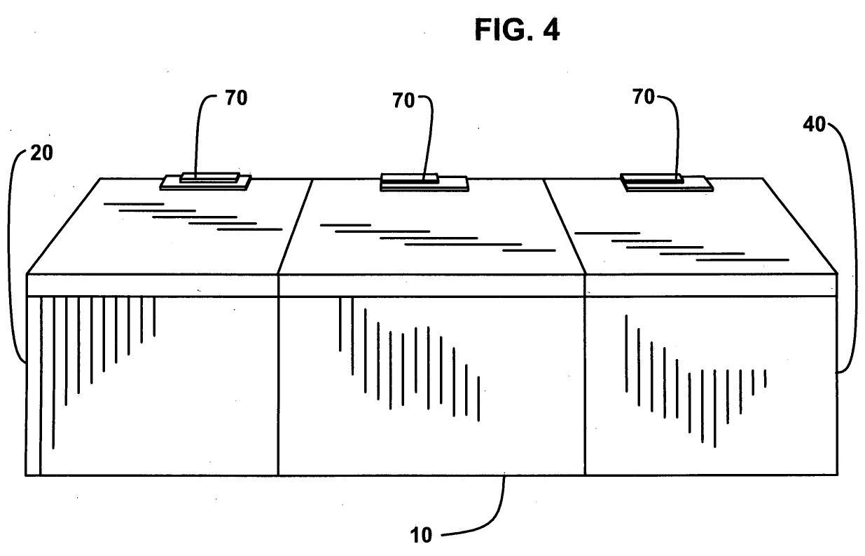

As seen in FIG. 3, the right end member 40 has a top ledge 41 and sidewall 42 and an end wall 43. The top ledge 41 has a top or outer surface 44 and an inner or bottom surface 45. Similarly, the sidewall has an inner surface 46 and an outer surface 47. The end wall 43 has an inner surface 48 and an outer surface 49. The top ledge 41, the sidewall 42 and the end wall 43 are generally at right angles to each other. Inner surface 48 of the end wall has a means 50 for receiving an end of a pole (not shown). The means for receiving can be any one of the well known end pieces for holding a pole, for example, in a closet or the like. One common type is a generally circular member that receives a round pole in the recessed center portion 51. The side walls 52 of the U hold the end of the pole in position.

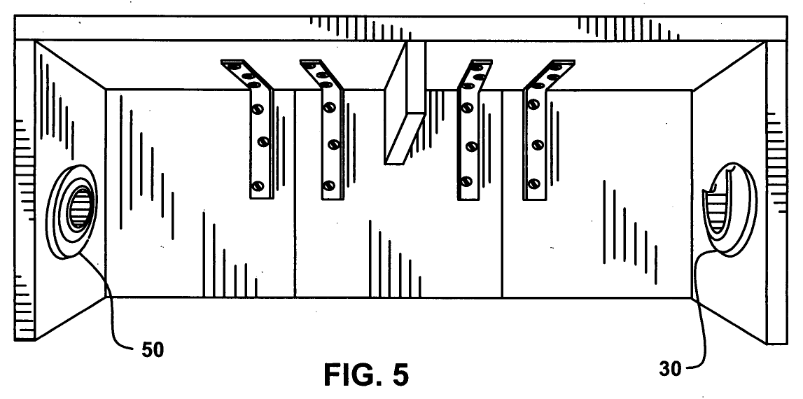

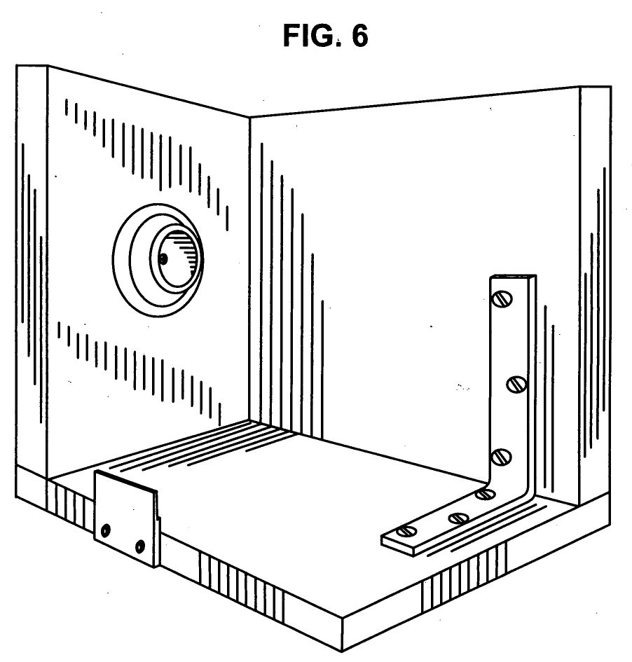

As seen in FIG. 4, there are two end members, a left member 20 and a right end member 40 that are separated by one center member 10. As noted above the three members can vary in width depending on the size of the windows they will be used on. For example, if the left and right end members are 12 inches wide and their center members are 6″ and 12″, the system can be used to span windows that are 24″, 30″, 36″, 42″, 48″ and so forth depending on the combination and number of center members. Varying the widths of the end members and center members can similarly provide endless combinations to cover windows of every conceivable size. In one embodiment, the end frame members and the center frame members are not secured directly to each other. The frame members are individually secured to the support and not to each other. In another embodiment, the frame members may be secured to each other by any suitable means.

One of the problems many homeowners, designers and decorators have in installing draperies and the like is the difficulty in securing the framework to a wall. In the present invention, there is a support member from which the end frame members and the center frame member can be hung. The support member 60 can be any length desired. In addition, there can be a plurality of support members if desired.

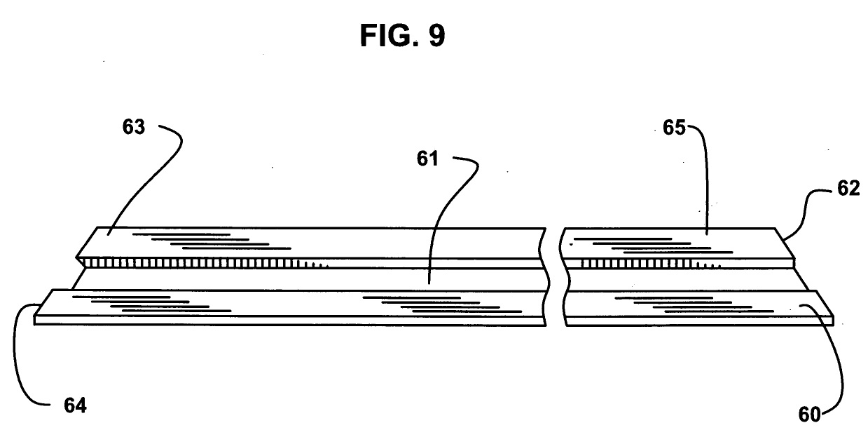

In a typical installation, the support member is a length of metal see FIG. 9. The length can vary depending on the size of the window. The length of member 60 has a front surface 61, a rear surface 62, a top edge 63 and a bottom edge 64. There are preferably a plurality of orifices 65 in the front surface 61 of the support member. The orifices are used to secure the support member to the wall surface or portion of the molding or frame around a window. The support member can be secured to the wooden studs or to the sheetrock, plaster or concrete by using the appropriate anchor. The support member has a means for securing the end frame members and center frame members to the support member. This is usually done by hanging frame members onto the support member.

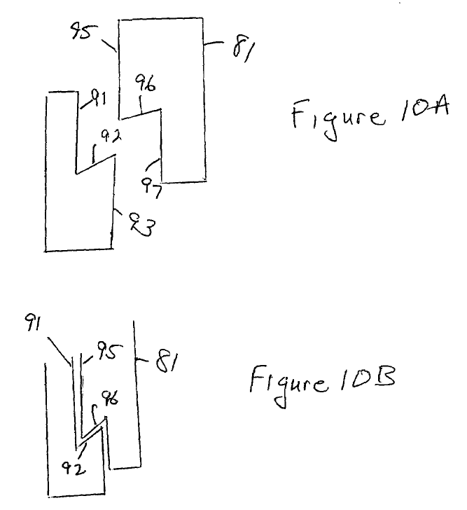

A preferred support member may be a support member having a side profile as shown in FIG. 10. The outer surface of the support member, has a first length 91, a support length 92 that forms an acute angle with the first length and a second length 93. The support length 92 forms a support surface for a corresponding securing means 81 on the edge of the center frame members. The securing means has a first length 95 and a support length 96 and a second length 97. The support lengths 92 and 96 contact each other. The angle between the support lengths and the front lengths are preferably greater than 0° and 90° or less.

In an alternative embodiment there can be a plurality of a hook and eye members securing the frames to the support. The support member may be one or more hooks and there may be one or more eyes on each of the frame members. It will be appreciated that any of a variety of different methods may be used to secure the frame members to a wall surface.

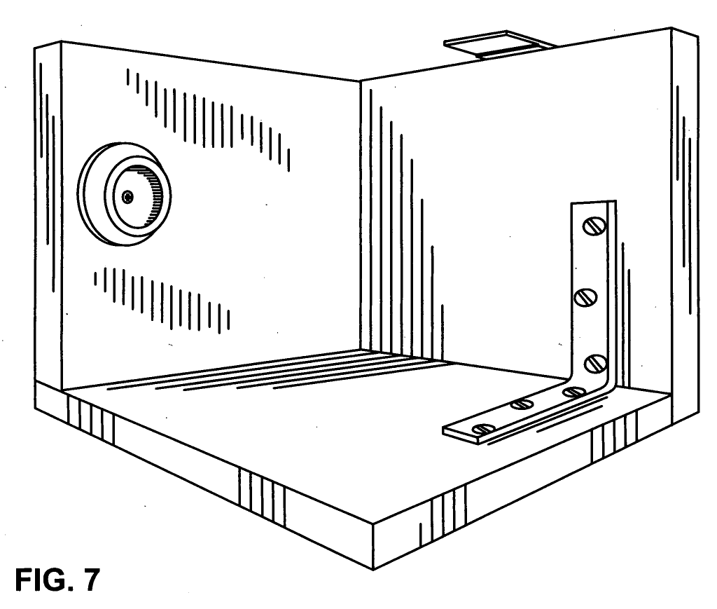

Once the appropriate width frame members are positioned onto the support member, the homeowner, decorator or designer can secure fabric to the top surface of the frame member and install the valance. Velcro, double sided tape, tacks, etc., can be used to secure the fabric to the surface of the frame and end members. FIG. 4 shows a strip of velcro 70 on the top surface of the frame and end members. Similarly, the draperies can be hung using the pole support on the end frame members. These pole supports are seen in FIG. 5 which is a rear view of the arrangement of FIG. 4. The pole members 30 and 50 receive a pole from which draperies, curtains and the like can be hung.

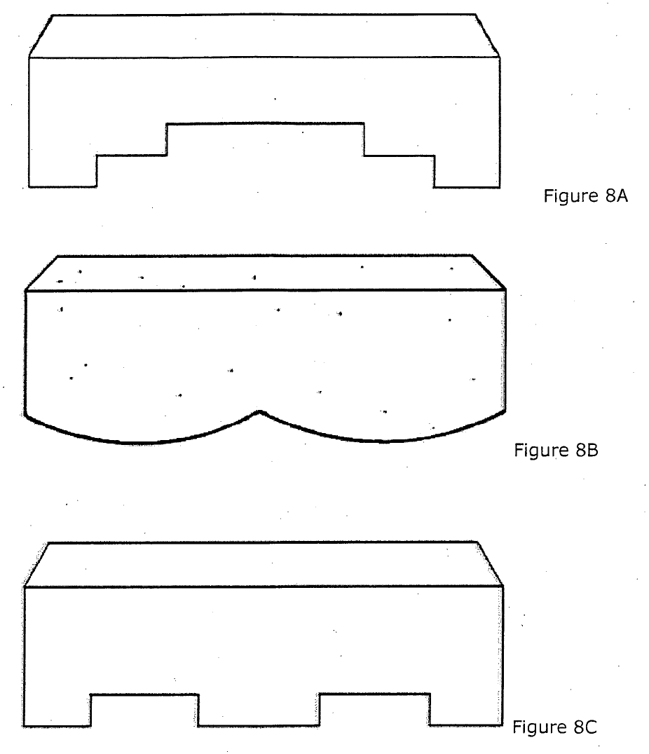

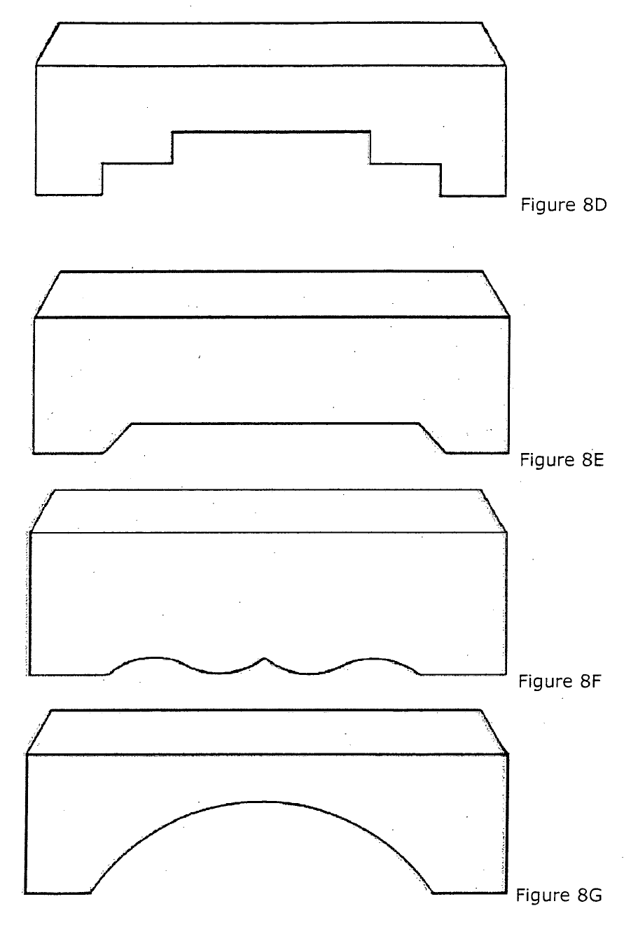

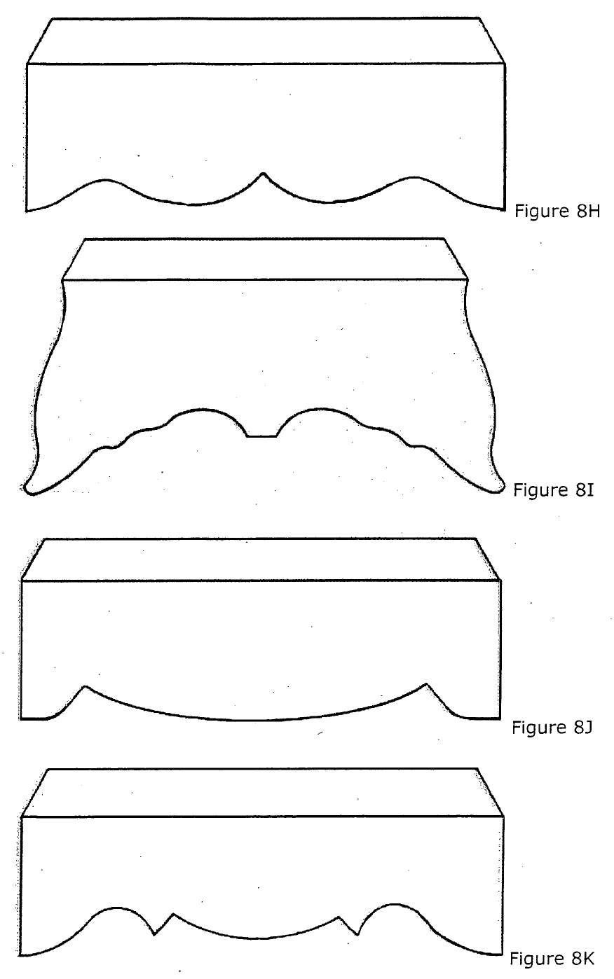

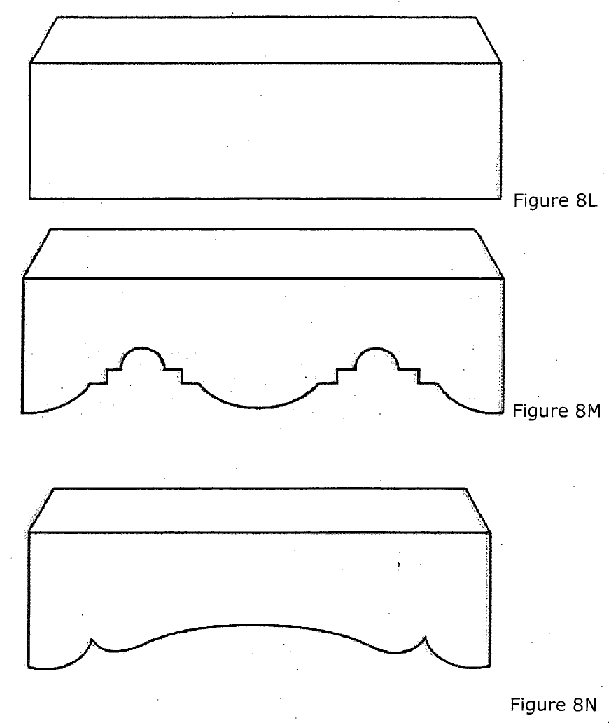

FIG. 8 shows representative samples of the shape of the outer surfaces 15, 27 and 47 to give the decorator, homeowner and designer a variety of looks to the cornice system of the present invention.

In addition to the use of this invention for fabric covered window treatments there are other applications for the present invention as well. For example, the modular system can be used as shelving and attached to a wall over a bed as a partial canopy. Also, the present invention can be used without a fabric covering.

I claim:

1. A window treatment system comprising a support member that is adapted to be secured to a surface above a window, said support member having removably attached thereto a left end frame member and a right end frame member each of said frame members having a top ledge a side wall extending from one end of said top ledge and an end wall, said top ledge and said side wall of said frame members having an inside edge and an outside edge, said inside edge being adapted to contact the respective inside edges of the opposite end frame member, said outside edge of said top ledge and said side wall having said end wall adjacent thereto said left end member and said right end member forming a support for a window treatment, said window treatment being securable to said end frame members.

2. The window treatment system according to claim 1 wherein there are one or more center frame members between said left and right end frame members, said center frame member having a top ledge and a side wall, said center frame member being adapted to be removably secure to said support member.

3. The window treatment system according to claim 1 wherein each of said top ledges has an outer surface and said outer surface of said top edge of said left end frame member and the top ledge of said right end frame member are in generally the same plane.

4. The window treatment system according to claim 3 wherein said sidewalls have an outer surface and said outer surfaces are generally in the same plane.

5. The window treatment system according to claim 1 wherein said top ledge and said sidewall are about 90° to each other.

6. The window treatment system according to claim 5 wherein said end wall is at a right angle to said top ledge and said sidewall.

7. The window treatment system according to claim 1 wherein each of said end walls has an inner surface, said inner surface having a means for supporting one end of a pole.

8. The window treatment system according to claim 3 wherein said top ledge has one or more means thereon for securing a fabric to said end frame members.

9. The window treatment system according to claim 2 wherein said top ledge has one or more means thereon for securing a fabric to said frame members.

10. A window treatment system comprising a support member that is adapted to be secured to a surface above a window, said support member having removably attached thereto a left end frame member, a right end frame member and one or more center frame members, each of said frame members having a top ledge and a side wall extending from one end of said top ledge, said end frame members further comprising an end wall, said top ledge and said side wall of said frame members having an inside edge and an outside edge, said inside edge of each end frame member being adapted to contact the respective edges of the adjacent center frame member, said outside edge of said top ledge and said side wall of each of said end frame members having said end wall adjacent thereto said end members forming a support for a window treatment, said window treatment being securable to said frame members.

11. The window treatment system according to claim 10 wherein each of said top ledges has an outer surface and said outer surface of said top edge of said left end frame member and the top ledge of said right end frame member are in generally the same plane.

12. The window treatment system according to claim 11 wherein said sidewalls have an outer surface and said outer surfaces are generally in the same plane.

13. The window treatment system according to claim 12 wherein said top ledge and said sidewall are about 90° to each other.

14. The window treatment system according to claim 13 wherein said end wall is at a right angle to said top ledge and said sidewall.

15. The window treatment system according to claim 14 wherein each of said end walls has an inner surface, said inner surface having a means for supporting one end of a pole.

16. The window treatment system according to claim 15 wherein said top ledge has one or more means thereon for securing a fabric to said end frame members.

17. A frame member for a window treatment system comprising a top ledge and a side wall extending from one end of said top ledge, said top ledge and said side wall of said frame member having an inside edge and an outside edge, said inside edge being adapted to contact the respective inside edge of an adjacent frame member, said end of said top ledge opposite said side wall being adapted to be removably securable to a support member secured to a wall and wherein said top ledge and said side wall are generally in the same plane, and wherein at least one of said top ledge and said sidewall are adapted to have at least a portion of a window treatment secured thereto.

18. The frame member according to claim 17 where there is an end wall on said outside edge of said top ledge and said sidewall.
